(19) United States
(12) Patent Application Publication
(10) Pub. No.: US 2026/0206665 A1
(43) Pub. Date: Jul. 23, 2026

(54) MANUAL LAWN AERATOR

(71) Applicant: Suzhou Grand Star Technology Co., Ltd., Suzhou (CN)

(72) Inventor: Yanan SHEN, Suzhou (CN)

(21) Appl. No.: 19/286,147

(22) Filed: Jul. 30, 2025

(30) Foreign Application Priority Data
Jan. 22, 2025 (CN) 202520144848.5

(51) Int. Cl. A01B 1/24

(52) U.S. Cl. CPC A01B 1/243

(57) ABSTRACT

A manual lawn aerator includes a bracket forming a mounting groove; a pushing rod fixedly connected to the bracket; a rolling assembly including a rolling body rotatably connected to the bracket and a plurality of spikes distributed on a circumferential surface of the rolling body, and a portion of the rolling body being partially accommodated in the mounting groove; and a pair of auxiliary wheels provided on both sides of the bracket, respectively.

### CROSS-REFERENCE TO RELATED APPLICATIONS

This application claims priority to Chinese Patent Application No. 2025201448485 filed on Jan. 22, 2025, entitled “MANUAL LAWN AERATOR”, the entire content of which is incorporated herein by reference in its entirety.

### TECHNICAL FIELD

The present disclosure relates to the technical field of lawn aerators, and in particular to a manual lawn aerator.

### BACKGROUND

Most lawns are formed by densely planting short herbaceous plants. Dense herbaceous plants make it difficult for oxygen, water, fertilizer, etc. to reach the bottom of the lawn, resulting in low levels of oxygen, water, fertilizer, etc. at the bottom of the lawn. In order to aerate and oxygenate the lawn and increase the moisture and fertilizer content at the bottom of the lawn, an aerator is usually used to punch a plurality of holes of a certain depth on the lawn, so that oxygen can reach the bottom of the lawn through the holes.

The conventional manual lawn aerator is heavy and difficult to move after use. If it is dragged forcibly, spikes on the manual lawn aerator will rub against the ground, cutting the ground and causing friction damage to the spikes.

### SUMMARY

Accordingly, a manual lawn aerator is provided, which can be conveniently moved after use.

A manual lawn aerator includes: a bracket forming a mounting groove; a pushing rod fixedly connected to the bracket; a rolling assembly including a rolling body rotatably connected to the bracket and a plurality of spikes distributed on a circumferential surface of the rolling body, and a portion of the rolling body being partially accommodated in the mounting groove; and a pair of auxiliary wheels provided on both sides of the bracket, respectively.

In an embodiment, the bracket includes a protecting cover and a pair of side plates, the protecting cover is arc-shaped, the pair of side plates are respectively fixed on both sides of the protecting cover, and the protecting cover and the pair of side plates cooperatively form the mounting groove.

In an embodiment, the bracket further includes an auxiliary rod provided at an edge of the protecting cover and extends through the pair of side plates, and the pair of auxiliary wheels are located on both ends of the auxiliary rod, respectively.

In an embodiment, the pair of side plates are provided with two shaft holes, respectively, the rolling assembly further includes a pair of rotating shafts rotatably received in the two shaft holes, respectively, and the rolling body is capable of rotating around the pair of rotating shafts.

In an embodiment, the bracket further includes a cross bar, both ends of the cross bar are fixedly connected to the pair of side plates, respectively, and the pushing rod is fixedly connected to the cross bar.

In an embodiment, the rolling body is provided with an accommodating cavity therein, and the accommodating cavity is configured to accommodate a counterweight member.

In an embodiment, the rolling body is provided with an assembly opening in communication with the accommodating cavity, and the counterweight member is placed in the accommodating cavity through the assembly opening.

In an embodiment, the assembly opening is formed on an end surface of the rolling body.

In an embodiment, the rolling assembly further includes a sealing cover configured to seal the assembly opening.

In an embodiment, the sealing cover is threadedly connected to an inner peripheral wall of the assembly opening.

By providing the pair of auxiliary wheels on the bracket, the entire lawn aerator can be conveniently moved when not in use, so as to avoid the friction between the spikes and the ground, which will cause friction damage to the spikes while cutting the ground.

In addition, by accommodating the counterweight member in the accommodating cavity of the rolling body, the manual lawn aerator is easy and convenient to operate, has a good penetration effect, and is easy and convenient to operate. When in use, the user can put an appropriate amount of counterweight member into the accommodating cavity as needs. No additional fixing structure is required to fix the counterweight member, providing a good user experience.

The details of one or more embodiments of the application are set forth in the accompanying drawings and the description below. Other features, objects, and advantages of the application will be apparent from the description and drawings, and from the claims.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a perspective view of a manual lawn aerator.

FIG. 2 is an enlarged perspective view of the manual lawn aerator of FIG. 1.

FIG. 3 is similar to FIG. 2, but showing a sealing cover sealing an assembly opening in FIG. 2.

FIG. 4 is a partial cross-sectional view of the manual lawn aerator.

FIG. 5 is a perspective view of a bracket of the manual lawn aerator in FIG. 1.

Reference numerals: 1. Pushing rod; 10. Hand-held end; 11. mounting end; 12. Handle; 2. Rolling assembly; 20. Rolling body; 200. Receiving cavity; 201. Assembly opening; 21. Spike; 22. Sealing cover; 23. Rotating shaft; 3. Bracket; 30. Mounting groove; 31. Shaft hole; 32. Protecting cover; 33. Side plate; 34. Cross bar; 35. Auxiliary rod; 36. Auxiliary wheel; 37. Bearing; 38. Reinforcement rib.

### DETAILED DESCRIPTION OF THE EMBODIMENTS

The following provides a non-limiting detailed description of the technical solution of the present disclosure in conjunction with the embodiments and the accompanying drawings. In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential direction” are based on the azimuths or position relationships shown in the attached drawings. In addition, the terms “first” and “second” are only used for descriptive purposes and cannot be understood as indicating or implying relative importance or implicitly indicating the number of indicated technical features. Thus, the features defined with “first” and “second” may explicitly or implicitly include at least one of the features. In the description of the present disclosure, “a plurality of” means at least two, such as two, three, etc., unless otherwise expressly and specifically defined. The embodiments described below with reference to the accompanying drawings are exemplary and are intended to be used to explain the present disclosure, but should not be construed as limiting the present disclosure.

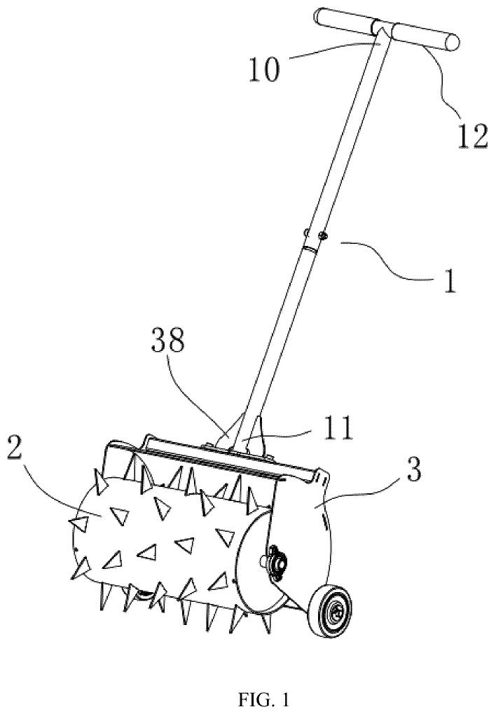

Referring to FIGS. 1 to 5, a manual lawn aerator according to one embodiment of the present disclosure includes a pushing rod 1, a rolling assembly 2, and a bracket 3. The pushing rod 1 is fixed to the bracket 3, and the rolling assembly 2 is rotatably mounted on the bracket 3. The pushing rod 1 is configured to be held by a user to drive the rolling assembly 2 to rotate on the soil and perform lawn aeration operations.

Referring to FIG. 1, the pushing rod 1 has a hand-held end 10 and a mounting end 11 that are opposite to each other. The rolling assembly 2 is located at the mounting end 11 of the pushing rod 1, and the rolling assembly 2 can roll under the driving of the pushing rod 1. The hand-held end 10 is provided with a handle 12 for the user to hold.

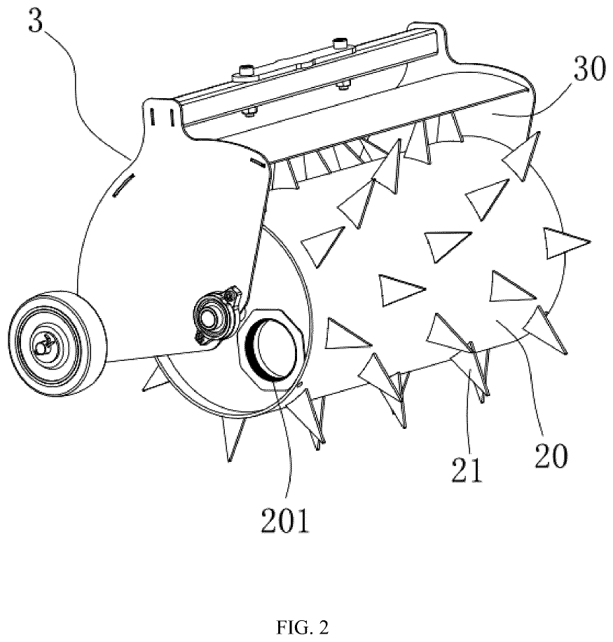

Referring to FIG. 2, the rolling assembly 2 includes a rolling body 20 and a plurality of spikes 21 distributed on the circumferential surface of the rolling body 20. The rolling body 20 has a cylinder shape, and the plurality of spikes 21 are regularly arranged on the circumferential surface of the rolling body 20, for example, in a spiral arrangement. When the pushing rod 1 is pushed forward, the rolling body 20 with the spikes 21 rolls on the lawn, and a number of small holes are formed on the lawn, which can aerate the lawn and make the grass healthier.

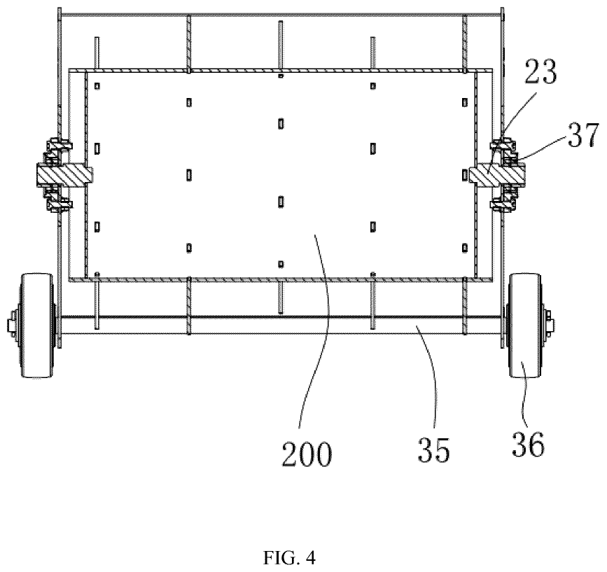

Referring to FIG. 4, the rolling body 20 is provided with an accommodating cavity 200 therein. The accommodating cavity 200 is configured to accommodate counterweight member. The weight of the rolling assembly 2 can be increased by the counterweight member, so that the rolling assembly 2 has a better penetration effect on the lawn. The weight material includes but is not limited to sand or water. When in use, the user can place an appropriate amount of counterweight member into the accommodating cavity 200 as needs, which is easy and convenient to operate. The counterweight members are not easy to fall off and no additional fixing structure is required, which optimizes the structure and provides a good user experience.

Referring to FIG. 2, the rolling body 20 is provided with an assembly opening 201 in communication with the accommodating cavity 200. The counterweight member is placed in the accommodating cavity 200 through the assembly opening 201. The counterweight members can be added conveniently and quickly, and no additional fixing structure is required to fix the counterweight members. The assembly opening 201 is formed on an end surface of the rolling body 20, so that the normal rolling of the rolling body 20 is not affected.

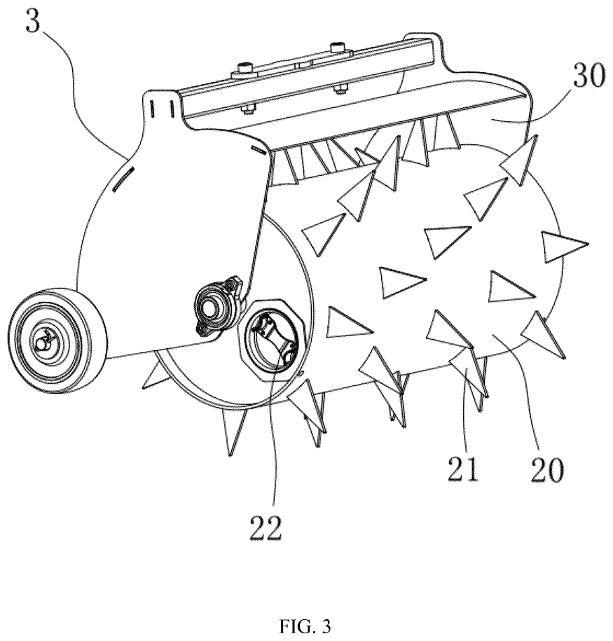

Referring to FIG. 3, the rolling assembly 2 further includes a sealing cover 22, and the sealing cover 22 is configured to seal the assembly opening 201. In this embodiment, the sealing cover 22 is threadedly connected to an inner peripheral wall of the assembly opening 201. Certainly, they may be fixedly connected by other means such as locking.

Referring to FIG. 3, the bracket 3 forms a mounting groove 30. The rolling body 20 is rotatably connected to the bracket 3, and the rolling body 20 is partially accommodated in the mounting groove 30.

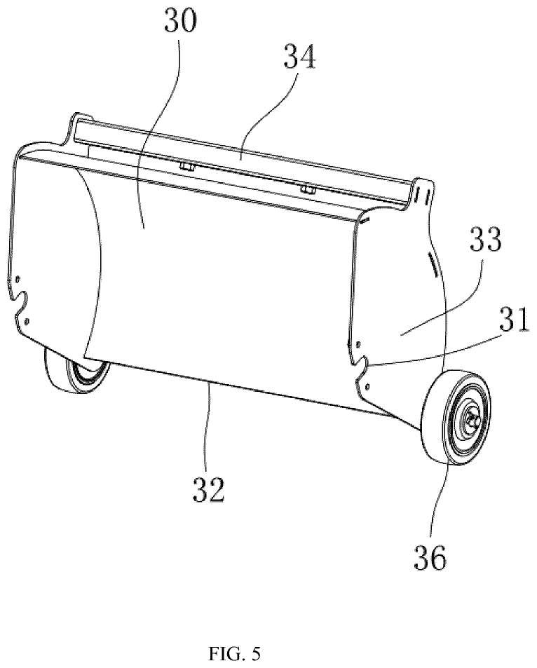

Referring to FIG. 5, both sides of the bracket 3 are provided with two shaft holes 31, respectively. The rolling assembly 2 further includes a pair of rotating shafts 23 coaxially provided. The pair of rotating shafts 23 are symmetrically arranged on both sides of the rolling body 20. The rolling body 20 can rotate around the pair of rotating shafts 23, and the pair of rotating shafts 23 are rotatably received in the shaft holes 31, respectively. Specifically, the rotating shafts 23 are connected to the bracket 3 through two bearings 37.

Referring to FIG. 5, the bracket 3 includes a protecting cover 32 and a pair of side plates 33. The protecting cover 32 and the pair of side plates 33 can be fixed by welding. The protecting cover 32 is arc-shaped, and the pair of side plates 33 are fixed on both sides of the protecting cover 32, respectively. The protecting cover 32 and the pair of side plates 33 cooperatively form the mounting groove 30, and the shaft holes 31 are formed on the pair of side plates 33.

The bracket 3 further includes a cross bar 34, both ends of which are fixedly connected to the pair of side plates 33, respectively, and the pushing rod 1 is fixedly connected to the cross bar 34. In this embodiment, the cross bar 34 is fixedly connected to the side plate 33 by welding, and the pushing rod 1 is fixedly connected to the cross bar 34 by screws. In addition, reinforcing ribs 38 are provided at the connection between the pushing rod 1 and the cross bar 34. The reinforcing ribs 38 can enhance the connection strength between the pushing rod 1 and the cross bar 34, making the entire structure more stable.

Referring to FIG. 5, the manual lawn aerator further includes a pair of auxiliary wheels 36, which are provided on both sides of the bracket 3, respectively.

Specifically, Referring to FIG. 4, the manual lawn aerator further includes an auxiliary rod 35, which is provided at an edge of the protecting cover 32 and extends through the pair of side plates 33. The pair of auxiliary wheels 36 are located on both ends of the auxiliary rod 35, respectively. By providing the auxiliary wheels 36, the entire lawn aerator can be conveniently moved when not in use, so as to avoid the friction between the spikes 21 and the ground, which will cause friction damage to the spikes 21 while cutting the ground. Meanwhile, the auxiliary wheels 36 can also support the entire lawn aerator when not in use, keeping the pushing rod 1 in an approximately vertical state.

Although the respective embodiments have been described one by one, it shall be appreciated that the respective embodiments will not be isolated. Those skilled in the art can apparently appreciate upon reading the disclosure of this application that the respective technical features involved in the respective embodiments can be combined arbitrarily between the respective embodiments as long as they have no collision with each other. Of course, the respective technical features mentioned in the same embodiment can also be combined arbitrarily as long as they have no collision with each other.

The foregoing descriptions are merely specific embodiments of the present disclosure, but are not intended to limit the protection scope of the present disclosure. Any variation or replacement readily figured out by a person skilled in the art within the technical scope disclosed in the present disclosure shall all fall within the protection scope of the present disclosure. Therefore, the protection scope of the present disclosure shall be subject to the protection scope of the appended claims.

What is claimed is:

1. A manual lawn aerator, comprising:
a bracket forming a mounting groove;
a pushing rod fixedly connected to the bracket;
a rolling assembly comprising a rolling body rotatably connected to the bracket and a plurality of spikes distributed on a circumferential surface of the rolling body, and a portion of the rolling body being partially accommodated in the mounting groove; and
a pair of auxiliary wheels provided on both sides of the bracket, respectively.

2. The manual lawn aerator according to claim 1, wherein the bracket comprises a protecting cover and a pair of side plates, the protecting cover is arc-shaped, the pair of side plates are respectively fixed on both sides of the protecting cover, and the protecting cover and the pair of side plates cooperatively form the mounting groove.

3. The manual lawn aerator according to claim 2, wherein the bracket further comprises an auxiliary rod provided at an edge of the protecting cover and extends through the pair of side plates, and the pair of auxiliary wheels are located on both ends of the auxiliary rod, respectively.

4. The manual lawn aerator according to claim 2, wherein the pair of side plates are provided with two shaft holes, respectively, the rolling assembly further comprises a pair of rotating shafts rotatably received in the two shaft holes, respectively, and the rolling body is capable of rotating around the pair of rotating shafts.

5. The manual lawn aerator according to claim 2, wherein the bracket further comprises a cross bar, both ends of the cross bar are fixedly connected to the pair of side plates, respectively, and the pushing rod is fixedly connected to the cross bar.

6. The manual lawn aerator according to claim 1, wherein the rolling body is provided with an accommodating cavity therein, and the accommodating cavity is configured to accommodate a counterweight member.

7. The manual lawn aerator according to claim 6, wherein the rolling body is provided with an assembly opening in communication with the accommodating cavity, and the counterweight member is placed in the accommodating cavity through the assembly opening.

8. The manual lawn aerator according to claim 7, wherein the assembly opening is formed on an end surface of the rolling body.

9. The manual lawn aerator according to claim 7, wherein the rolling assembly further comprises a sealing cover configured to seal the assembly opening.

10. The manual lawn aerator according to claim 9, wherein the sealing cover is threadedly connected to an inner peripheral wall of the assembly opening.
